(19) United States
(12) Patent Application Publication
(10) Pub. No.: US 2006/0287846 A1
(43) Pub. Date: Dec. 21, 2006

(54) Generating grammar rules from prompt text

(75) Inventor: David G. Ollason, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/158,128

(22) Filed: Jun. 21, 2005

(51) Int. Cl. G06F 17/28

(52) U.S. Cl. 704/4

(57) ABSTRACT

A speech grammar is generated using possible answer forms to input prompts. In one embodiment, input prompts are provided to a response prediction system which generates predicted responses to the input prompts. A grammar is pre-populated with the predicted responses.

### BACKGROUND

Speech recognition systems are currently used in a wide variety of applications. Many speech recognition systems use grammars, such as context free grammars (CFGs). As is known, CFGs use a set of rules yeilding words (or tokens) to identify words in a spoken utterance. Authoring these grammars is often one of the most difficult tasks in developing a speech recognition system for a given implementation.

One reason that authoring grammars is so difficult relates to the wide variety of different ways that different users tend to phrase inputs to the speech recognition system. For instance, assume that the implementation for a given speech recognition system is an interactive voice response (IVR) dialog implementation at a pizza restaurant, which accepts orders for pizzas over the phone. Assume further that the IVR unit asks a caller, at some point during the dialog, “What size pizza would you like?” Users will respond to this in many different ways, even if they are all ordering the same size pizza. For instance, users may respond in any of the following ways, or in even other ways:

I'd like a large pizza.

Please give me a large pizza.

I'll take a large pizza please.

I'd like a large pizza please.

I'll have a large pizza, thanks:

These examples illustrate that even though the content portion of the response (that portion of the response which actually answers the prompt) “large pizza” is the same for each example, the preamble (those words preceding the content portion of the response) and the postambles (those words following the content portion of the response) differ widely.

In order for a speech recognition system to handle all of these responses, the grammar in the speech recognition system must contain a rule that accommodates each of these responses. Therefore, in authoring the grammar, the grammar author must not only have knowledge about how users will respond with content (e.g., small, medium, or large pizza), but the grammar author must also be able to think of all of these different preambles and postambles. If the preambles and postambles are not present in the rules in the grammar, then the speech recognition system will not recognize the response by the user.

One way of addressing this problem involves using an already-authored grammar. An already-existing path through the grammar is specified, and the grammar is asked to predict other paths through the grammar, given the specified path. The grammar is then reconfigured to activate the predicted paths through the grammar when the specified path is activated.

Another way of addressing this problem involves manual transcription. In the exemplary pizza restaurant implementation being discussed, prior to implementing the automated dialog system at the pizza restaurant, a manual system is used in which a human operator speaks with customers and asks the customers the prompt: “What size pizza would you like?” The vocal answers from the customers are then all recorded and transcribed for later use by the grammar author. By reviewing all of the transcribed customer responses, the grammar author is better able to predict the different preambles and postambles that might commonly be used in response to the prompt. Of course, this is relatively time consuming and requires a relatively large amount of resources, and in any case, is anecdotal and subject to error.

The present invention addresses one, some or all of these problems, or it can be used to address different problems, as will be evident by reading the following description.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A speech grammar is generated using possible answer forms to input prompts. In one embodiment, input prompts are provided to a natural language generation system which generates predicted responses to the input prompts. In one embodiment, a grammar is pre-populated with preambles and postambles from the predicted responses.

### BRIEF DESCRIPTION OF THE DRAWINGS

FIG. 1 is one illustrative environment in which the present invention can be used.

FIG. 2 is a block diagram of a grammar generation system in accordance with one embodiment of the present invention.

FIG. 3 is a flow diagram illustrating the operation of the system shown in FIG. 2, in accordance with one embodiment of the present invention.

FIG. 4 is one illustrative user interface display, in accordance with one embodiment of the present invention.

### DETAILED DESCRIPTION OF ILLUSTRATIVE EMBODIMENTS

The present invention relates generally to grammar authoring or grammar generation. However, before describing the present invention in greater detail, one illustrative environment in which the present invention can be used will be described.

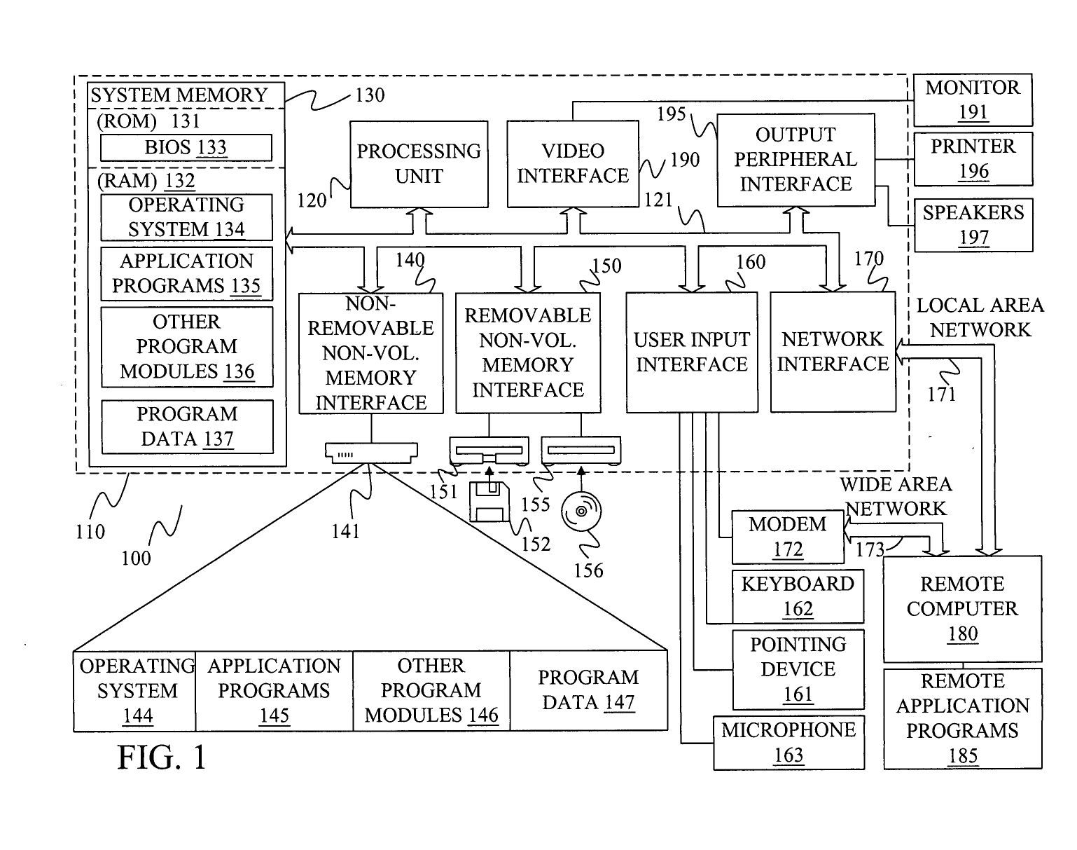

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

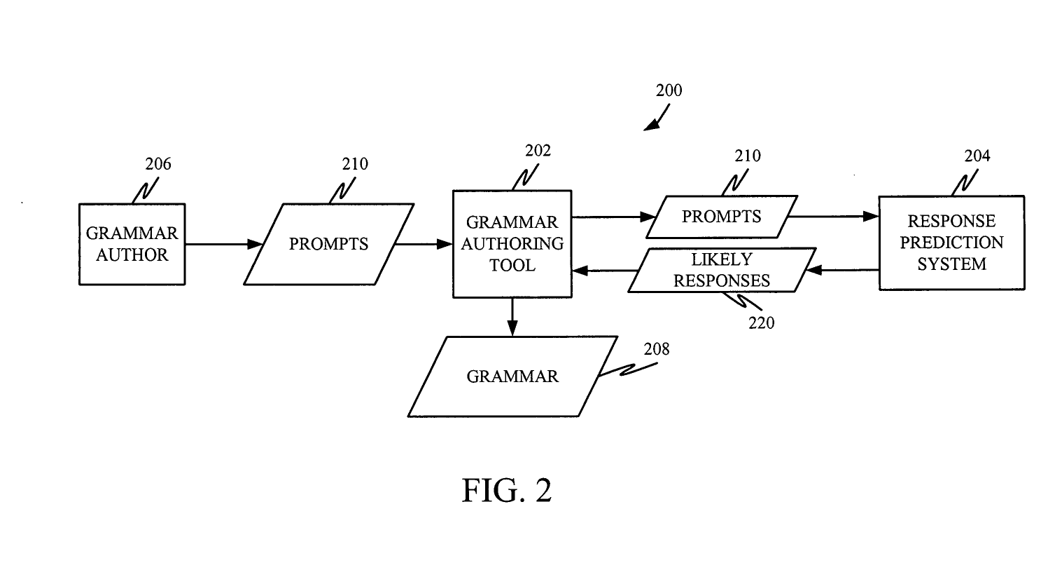

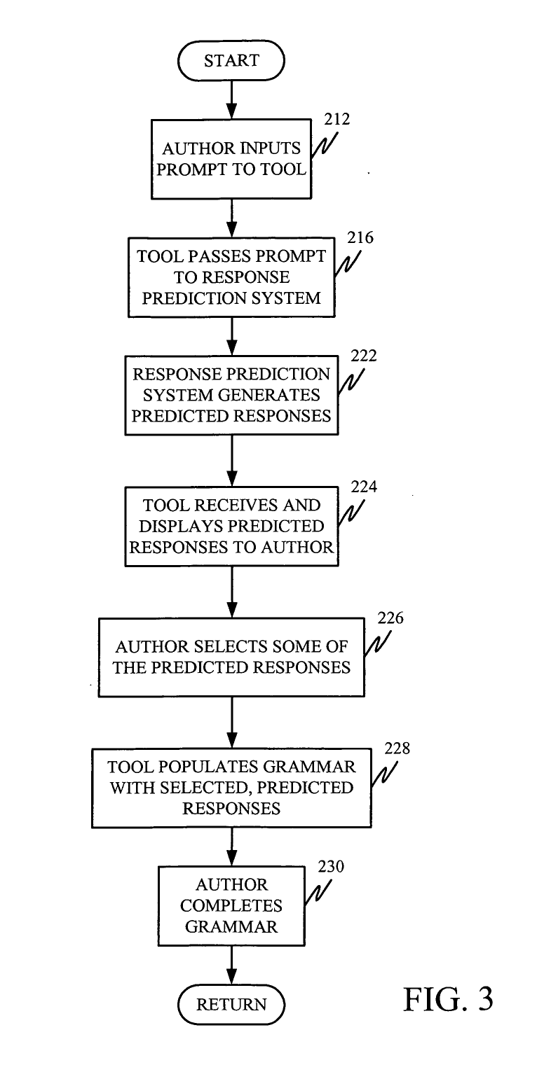

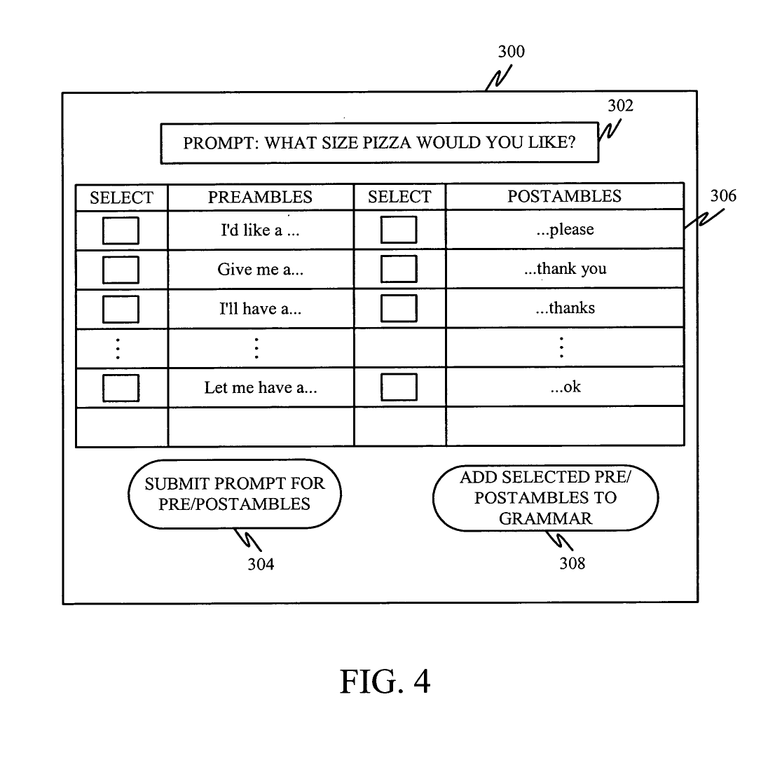

FIG. 2 is a block diagram of a grammar authoring system 200 in accordance with one embodiment of the present invention. System 200 includes grammar authoring tool 202 that communicates with response prediction system 204, based on inputs by a grammar author 206, in order to generate grammar 208. FIG. 3 is a flow diagram illustrating the operation of system 200 shown in FIG. 2, in accordance with embodiment of the present invention. FIG. 4 is one illustrative user interface display illustrating how grammar author 206 interacts with one system 200, in accordance with one embodiment of the present invention. FIGS. 2, 3 and 4 will be described in conjunction with one another.

In order to begin operation of system 200, grammar author 206 generates one or more prompts which will be used in a speech system (such as a dialog system or IVR system) in which the speech recognition system that uses grammar 208 will be deployed. For the sake of example, assume that a dialog system will be implemented in a pizza restaurant to automatically take orders for pizzas from customers that call in on the telephone. Of course, this implementation is exemplary only and a wide variety of other implementations could be used as well.

In any case, in order to generate grammar 208 for that dialog system, grammar author 206 illustratively generates a plurality of prompts 210 that will be used in the dialog system. Such prompts may include, for example:

What size pizza would you like?

What kind of curst would you like?

What toppings would you like?

Grammar author 206 illustratively provides prompts 210 to the grammar authoring tool 202. This is indicated by block 212 in FIG. 3. The prompts 210 can illustratively be provided one at a time, or in groups.

One grammar authoring tool allows a grammar author 206 to generate a grammar by dragging and dropping portions of a graph, which represent the grammar rules, into a desired configuration. Of course, a wide variety of other grammar authoring tools can be used as well. One embodiment of a user interface display generated by grammar authoring tool 202 is shown in FIG. 4. FIG. 4 shows a display 300 that includes a text box 302 in which grammar author 206 can type prompts 210. Therefore, in accordance with one embodiment of the present invention, grammar author 206 provides one or more prompts 210 to grammar authoring tool 202 by typing it into text box 302. The exemplary prompt shown in FIG. 4 is: “What size pizza would you like?”

Grammar authoring tool 202 then provides the prompts 210 to response prediction system 204. Response prediction system 204 can be any type of system trained to predict responses to an input prompt. In one embodiment, the response prediction system 204 is a natural language generation system trained to generate one or more likely natural language outputs in response to a natural language input prompt. The natural language generation system can use any of a wide variety of technologies (such as language models, neural networks, natural language response look-up systems, lexical knowledge bases, information retrieval search systems, machine translation systems, localization systems, etc.) in order to predict user responses to the prompts 210 that are provided to it. This is indicated by block 216 in FIG. 3, and can be done in any suitable way.

FIG. 4 illustrates one embodiment in which user interface display 300 has a Submit button 304 which allows the grammar author 206 (by actuating Submit button 304 after the author has typed the prompt in text box 302) to have grammar authoring tool 202 send prompt 210 to response prediction system 204. This can illustratively be accomplished using an application programming interface (API) or other desirable mechanism.

Response predication system 204 receives the prompt 210 from grammar authoring tool 202 and generates likely responses 220 to the prompt 210. The responses can take any of a wide variety of forms. For instance, in one embodiment, the responses 220 are full responses to the prompt 210. In another embodiment, the responses 220 are likely preambles and postambles, which are predicted in view of the prompt 210. This latter embodiment is discussed herein for the sake of example.

Having response prediction system 204 generate predicted responses is indicated by block 222 in FIG. 3, and the responses 220 can be provided to grammar authoring tool 202 in any of a wide variety of ways, such as through an API, or another desired mechanism. The grammar 208 can then be automatically pre-populated with the likely responses 220, as discussed in greater detail below, without further action by the author 206, or they can be provided to author 206 for further review.

In either embodiment, the likely responses 220 can be displayed, through grammar authoring tool 202, to grammar author 206. This is indicated by block 224 in FIG. 3. FIG. 4 shows user interface display 300 with predicted responses (in this embodiment preambles and postambles) shown in Table 306. Table 306 shows four preambles which have been predicted including:

I'd like a . . .

Give me a . . .

I'll have a . . .

Let me have a . . . .

Of course, it will be noted that a wide variety of other preambles may be predicted, given the prompt, and only four are shown for the sake of example.

FIG. 4 also shows that table 305 lists a plurality of postambles including:

. . . please

. . . thank you

. . . thanks

. . . ok

Again, of course, a wide variety of other or different postambles might be predicted and those shown are for illustrative purposes only.

In accordance with one embodiment, after displaying the proposed responses, grammar authoring tool 202 simply pre-populates grammar 208 with the likely responses 220 without any further input by grammar author 206. The grammar author 206 can then provide further inputs to grammar authoring tool 202 in order to develop more content portions of the grammar, and in order to reconfigure the grammar, as desired.

However, in accordance with another embodiment, as illustrated in FIG. 4, grammar authoring tool 202 can illustratively display the likely responses 220 (the preambles and postambles) to the user and allow the user to select which of those likely responses the author desires in grammar 208. In the embodiment shown in FIG. 4, grammar authoring tool 202 displays a select box, which can be checked or otherwise selected by the user, next to each likely response. The user can select those likely responses that are desired, for instance by placing the cursor over the select box and clicking on it with a mouse. Selecting the predicted responses is indicated by block 226 in FIG. 3.

In this embodiment, once the grammar author 206 has selected desired responses, the grammar author 206 can then actuate Add button 308 (shown on user interface display 300 in FIG. 4) to add the likely responses to grammar 208. In response, grammar authoring tool 202 illustratively populates grammar 208 with the selected likely responses (in this case the preambles and postambles selected by grammar author 206), as is indicated by block 228 in FIG. 3.

Again, once the likely responses selected by the grammar author 206 have been populated into grammar 208, grammar author 206 can then complete the remaining portions of the grammar as desired. This is indicated by block 230 in FIG. 3.

It can thus be seen that proposed response forms to an input prompt in a dialog system can be used to generate a grammar. The proposed responses, in one embodiment, might simply include preambles and/or postambles. In another embodiment, the responses might include content as well. However, a grammar author may likely be well versed in, and have a relatively large amount of knowledge with respect to, content portions of the grammar, but may need most help in generating preambles and postambles. In that case, only the preambles and postambles need to be predicted. In either case, a natural language generation system can be used in order to generate the proposed responses, and the proposed responses can be automatically generated and populated into a grammar.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of authoring a grammar, comprising:
receiving, from a response prediction system, a plurality of proposed responses to a prompt; and
populating the grammar with the proposed responses.

2. The method of claim 1 wherein receiving the plurality of proposed responses comprises:
receiving a plurality of proposed preambles.

3. The method of claim 1 wherein receiving the plurality of proposed responses comprises:
receiving a plurality of proposed postambles.

4. The method of claim 1 wherein populating the grammar comprises:
displaying the proposed responses; and
receiving a user selection input identifying selected proposed responses.

5. The method of claim 4 wherein populating the grammar comprises:
populating the grammar with the selected proposed responses.

6. The method of claim 1 and further comprising:
receiving the prompt from the author; and
receiving a user actuation input to submit the prompt to the response prediction system.

7. The method of claim 1 wherein receiving the plurality of proposed responses comprises:
receiving the plurality of proposed responses from a natural language generation system.

8. A grammar authoring system, comprising:
a response prediction component configured to generate a plurality of proposed responses based on a linguistic input; and
a grammar authoring tool, operably coupled to the response prediction component, and configured to populate the grammar with the proposed responses.

9. The grammar authoring system of claim 8 wherein the grammar authoring component is configured to receive the linguistic input from a user and provide it to the response prediction component.

10. The grammar authoring system of claim 8 wherein the response prediction component comprises a natural language generation system.

11. The grammar authoring system of claim 10 wherein the linguistic input comprises a prompt from a dialog system in which the grammar is to be implemented.

12. The grammar authoring system of claim 11 wherein the natural language generation system generates, as the plurality of proposed responses, preambles and postambles to responses to the prompt.

13. The grammar authoring system of claim 12 wherein the grammar authoring tool comprises a user interface display that displays the preambles and postambles for selection by a user.

14. A computer readable medium storing computer readable instructions which, when executed by a computer, perform steps of:
receiving a prompt;
accessing a response prediction component to obtain a plurality of predicted responses to the prompt; and
populating a speech grammar with the proposed responses.

15. The computer readable medium of claim 14 and further comprising:
prior to populating the grammar, displaying the proposed responses for selection by a user.

16. The computer readable medium of claim 14 wherein the proposed responses comprise preambles and postambles to responses to the prompt.
